(19) United States
(12) Patent Application Publication
(10) Pub. No.: US 2024/0407400 A1
(43) Pub. Date: Dec. 12, 2024

(54) OAT FRACTIONATION PROCESS AND BEVERAGES PRODUCED THEREFROM

(71) Applicant: fairlife, LLC, Chicago, IL (US)

(72) Inventors: Dustin Grossbier, Minneapolis, MN (US); Shakeel Ur Rehman, Naperville, IL (US); Timothy P. Doelman, Glencoe, IL (US); Nicholas Adamson, Grand Rapids, MI (US)

(73) Assignee: fairlife, LLC, Chicago, IL (US)

(21) Appl. No.: 18/701,668

(22) PCT Filed: Oct. 24, 2022
(86) PCT No.: PCT/US2022/078602

§ 371 Date: Apr. 16, 2024

Related U.S. Application Data
(60) Provisional application No. 63/271,259, filed on Oct. 25, 2021.

(51) Int. Cl. A23L 2/74; A23L 2/84; A23L 5/10; A23L 7/104; B01D 61/14; B01D 69/02

(52) U.S. Cl. CPC A23L 2/74; A23L 2/84; A23L 5/10; A23L 7/107; B01D 61/146; B01D 69/02; B01D 2315/16; B01D 2325/34

(57) ABSTRACT

Methods for making oat compositions, such as oat-based beverages, include the steps of combining an oat flour composition with a base to produce a first aqueous mixture having a pH from 8.5 to 11.5, separating the first aqueous mixture into a solid fraction and a liquid fraction, combining the liquid fraction with an acid to form a second aqueous mixture having a pH from 5 to 9, ultrafiltering the second aqueous mixture to produce a UF permeate fraction and a UF retentate fraction, and combining the UF retentate fraction, one or more ingredients, and optionally water to form the oat composition.

### REFERENCE TO RELATED APPLICATION

This application is being filed on Oct. 24, 2022, as a PCT International Patent Application and claims the benefit of and priority to U.S. Provisional Patent Application No. 63/271,259, filed on Oct. 25, 2021, the disclosure of which is incorporated herein by reference in its entirety.

### BACKGROUND OF THE INVENTION

The present invention relates generally to the preparation of an oat-based composition or beverage from an oat flour composition using combinations of pH adjustment, liquid-solid separation, and ultrafiltration steps.

### SUMMARY OF THE INVENTION

This summary is provided to introduce a selection of concepts in a simplified form that are further described herein. This summary is not intended to identify required or essential features of the claimed subject matter. Nor is this summary intended to be used to limit the scope of the claimed subject matter.

Methods for preparing oat-based compositions, such as oat-based beverages, are disclosed and described herein. These methods can comprise the steps of (i) combining an oat flour composition with a base to produce a first aqueous mixture having a pH in a range from 8.5 to 11.5, (ii) separating the first aqueous mixture into a solid fraction and a liquid fraction, (iii) combining the liquid fraction with an acid to form a second aqueous mixture having a pH in a range from 5 to 9, (iv) ultrafiltering the second aqueous mixture to produce a UF permeate fraction and a UF retentate fraction, and (v) combining the UF retentate fraction, an ingredient, and optionally water to form the oat composition.

Both the foregoing summary and the following detailed description provide examples and are explanatory only. Accordingly, the foregoing summary and the following detailed description should not be considered to be restrictive. Further, features or variations can be provided in addition to those set forth herein. For example, certain aspects can be directed to various feature combinations and sub-combinations described in the detailed description.

### BRIEF DESCRIPTION OF THE FIGURE

The following FIGURE forms part of the present specification and is included to further demonstrate certain aspects of the present invention. The invention may be better understood by reference to this FIGURE in combination with the detailed description and examples.

FIG. 1 presents a schematic flow diagram of a production process for making an oat composition from oat flour.

### DEFINITIONS

To define more clearly the terms used herein, the following definitions are provided. Unless otherwise indicated, the following definitions are applicable to this disclosure. If a term is used in this disclosure but is not specifically defined herein, the definition from the TUPAC Compendium of Chemical Terminology, 2^{nd} Ed (1997), can be applied, as long as that definition does not conflict with any other disclosure or definition applied herein, or render indefinite or non-enabled any claim to which that definition can be applied. To the extent that any definition or usage provided by any document incorporated herein by reference conflicts with the definition or usage provided herein, the definition or usage provided herein controls.

Herein, features of the subject matter are described such that, within particular aspects, a combination of different features can be envisioned. For each and every aspect and/or feature disclosed herein, all combinations that do not detrimentally affect the designs, compositions, processes, and/or methods described herein are contemplated with or without explicit description of the particular combination. Additionally, unless explicitly recited otherwise, any aspect and/or feature disclosed herein can be combined to describe inventive designs, compositions, processes, and/or methods consistent with the present invention.

In this disclosure, while compositions and processes are often described in terms of “comprising” various components or steps, the compositions and processes also can “consist essentially of” or “consist of” the various components or steps, unless stated otherwise. For example, an oat-based composition consistent with aspects of the present invention can comprise; alternatively, can consist essentially of; or alternatively, can consist of; a UF retentate fraction, one or more ingredients, and water.

The terms “a,” “an,” and “the” are intended to include plural alternatives, e.g. at least one, unless otherwise specified. For instance, the disclosure of “an ingredient” is meant to encompass one or mixtures or combinations of more than one ingredient, unless otherwise specified.

In the disclosed methods, the term “combining” encompasses the contacting of components in any order, in any manner, and for any length of time, unless otherwise specified. For example, the components can be combined by blending or mixing.

Several types of ranges are disclosed in the present invention. When a range of any type is disclosed or claimed, the intent is to disclose or claim individually each possible number that such a range could reasonably encompass, including end points of the range as well as any sub-ranges and combinations of sub-ranges encompassed therein. For example, the UF retentate fraction can have a protein content from 1 to 15 wt. % in aspects of this invention. By a disclosure that the protein content is from 1 to 15 wt. %, the intent is to recite that the protein content can be any amount in the range and, for example, can include any range or combination of ranges from 1 to 15 wt. %, such as from 2 to 14 wt. %, from 3 to 15 wt. %, or from 3 to 12 wt. %, and so forth. Likewise, all other ranges disclosed herein should be interpreted in a manner similar to this example.

In general, an amount, size, formulation, parameter, range, or other quantity or characteristic is “about” or “approximate” whether or not expressly stated to be such. Whether or not modified by the term “about” or “approximately,” the claims include equivalents to the quantities or characteristics.

Although any methods, devices, and materials similar or equivalent to those described herein can be used in the practice or testing of the invention, the typical methods, devices, and materials are herein described.

All publications and patents mentioned herein are incorporated herein by reference in their entirety for the purpose of describing and disclosing, for example, the constructs and methodologies that are described in the publications and patents, which might be used in connection with the presently described invention.

### DETAILED DESCRIPTION OF THE INVENTION

Oats are a popular grain among health-conscious consumers. Indeed, segments of the population that regularly consume oatmeal have a lower body mass index (BMI) than non-consumers. Additionally, consumption of two servings of whole oats per day is associated with a lowering of overall and LDL profiles due to the presence of soluble fibers, in particular β-glucan.

Plant-based beverages—such as oat-based beverages—are gaining popularity, due in part to perceived health benefits and reduced environmental impact.

Nutritionally speaking however, these products derive a large portion of their calories from endogenous as well as added carbohydrates, primarily sugars. Diets high in carbohydrates have been found to increase triglyceride levels. Additionally, these products have relatively low protein content and rely on the addition of other sources of fat to contribute positive sensory and organoleptic attributes.

An objective of the present invention is a method that can minimize or eliminate the use of external sources of fat, while concurrently resulting in an oat-based composition or beverage with a customizable enrichment of protein and an advantageous reduction of sugars and other non-fiber carbohydrates. Another objective of the present invention is a method for the preparation of an oat-based composition or beverage having improved organoleptic properties and a reduced sugar/carbohydrate content. In particular, the oat-based composition or beverage has less off-flavors and off-odors—such as less grassy notes and less oxidized flavors—while achieving a creamy (non-gritty) mouthfeel with the consistency comparable to that of conventional 2% milk or whole milk.

### Methods of Making Oat Compositions

A method for making an oat composition can comprise (or consist essentially of, or consist of) (i) combining an oat flour composition with a base to produce a first aqueous mixture having a pH in a range from 8.5 to 11.5, (ii) separating the first aqueous mixture into a solid fraction and a liquid fraction, (iii) combining the liquid fraction with an acid to form a second aqueous mixture having a pH in a range from 5 to 9, (iv) ultrafiltering the second aqueous mixture to produce a UF permeate fraction and a UF retentate fraction, and (v) combining the UF retentate fraction, an ingredient, and optionally water to form the oat composition. Generally, the features of the method (e.g., the characteristics of the oat flour composition, the conditions under which each step is performed, the characteristics of the UF retentate fraction, and the characteristics of the oat composition, among others) are independently described herein and these features can be combined in any combination to further describe the disclosed method. Moreover, other process steps can be conducted before, during, and/or after any of the steps listed in the disclosed method, unless stated otherwise. Additionally, any oat compositions (e.g., oat-based beverages, ready for consumption) produced in accordance with any of the disclosed methods are within the scope of this disclosure and are encompassed herein.

Filtration technologies (e.g., microfiltration, ultrafiltration, nanofiltration, etc.) can separate or concentrate components in mixtures by passing the mixture through a membrane system (or selective barrier) under suitable conditions (e.g., pressure). The concentration or separation can be, therefore, based on molecular size. The stream that is retained by the membrane is called the retentate (or concentrate). The stream that passes through the pores of the membrane is called the permeate.

The oat flour composition in step (i) can contain any suitable components and at any relative amounts, and this encompasses typical oat flours (e.g., unground oat flour) and oat brans. The oat flour composition can be very susceptible to oxidation, which can lead to off-flavors and off-taste. The oat flour composition can be a dry composition (e.g., a free flowing powder) or it can be an aqueous mixture at any suitable solid content. While not limited thereto, when the oat flour composition is an aqueous mixture, the solids content can range from 1 to 40 wt. % solids, but more often ranges from 3 to 20 wt. % solids or from 5 to 15 wt. % solids.

On a dry basis, the protein content of the oat flour composition can range from 7 to 30 wt. % in one aspect, from 8 to 25 wt. % in another aspect, and from 9 to 18 wt. % in yet another aspect. The oat flour composition can have any suitable fat content, encompassing fat-free and low-fat oat flours and oat brans. Thus, ranges of fat content for the oat flour composition often include from 0 to 10 wt. % fat, from 1 to 10 wt. % fat, or from 2 to 8 wt. % fat.

The total dietary fiber content of the oat flour composition often ranges from 2 to 20 wt. %, from 3 to 18 wt. %, or from 3 to 15 wt. %, although not limited thereto. Of the total dietary fiber in the oat flour composition, the soluble dietary fiber content often can be the majority of the total fiber, and can be from 40 to 100 wt. % of the total dietary fiber; alternatively, from 50 to 100 wt. % of the total dietary fiber; or alternatively, from 60 to 100 wt. % of the total dietary fiber. Thus, in some aspects, all or substantially all of the total dietary fiber in the oat flour composition can be soluble dietary fiber. Of the soluble dietary fiber present in the oat flour, the low molecular weight soluble dietary fiber content can range from 0 to 100 wt. %, but more often, the low molecular weight soluble dietary fiber content ranges from 10 to 100 wt. %, or from 50 to 100 wt. %, based on the soluble dietary fiber.

Step (i) can be referred to as a high pH protein extraction step, and in step (i), the oat flour composition is combined with a base to produce a first aqueous mixture having a pH in a range from 8.5 to 11.5. Depending upon the form of the oat flour composition (dry composition or aqueous mixture) and the form of the base (solid or liquid), step (i) can be performed in a variety of ways, and this invention is not limited thereto. For instance, if the oat flour composition is an aqueous mixture, the base in solid form—or alternatively, in liquid form—can be added to the oat flour composition and mixed. Optionally, water can be added to the oat flour composition, to the base, or to the mixture of the oat flour composition and the base, or any combination thereof, if desired. Similarly, if the oat flour composition is dry/solid, water and the base in solid or liquid form can be combined with the oat flour composition in step (i).

The base in step (i) is not particularly limited, although often the base is a food-grade base. Illustrative and non-limiting examples of bases that can be used in step (i) include sodium hydroxide, potassium hydroxide, calcium hydroxide, sodium carbonate, or potassium carbonate, and the like. Combinations of two or more bases can be used.

After combining the oat flour composition with the base in step (i), the resulting first aqueous mixture has a pH in a range from 8.5 to 11.5. In some aspects, the pH in step (i) can be in a range from 9 to 11.5; alternatively, from 9 to 11; alternatively, from 9.5 to 11; alternatively, from 10 to 11.5; alternatively, from 10 to 11; or alternatively, from 10 to 10.5. Often, a higher pH is better, however, if the pH is too high and higher temperatures are encountered, saponification can result.

Step (i) can be performed and/or the first aqueous mixture can be formed at any suitable temperature. Beneficially, relatively low temperatures are used, with minimum temperatures, for instance, of 2° C., 3° C., or 5° C., and maximum temperatures of 30° C., 25° C., 20° C., or 15° C. Representative and non-limiting ranges for the temperature of step (i) and/or for the formation of the first aqueous mixture include from 2° C. to 30° C., from 3° C. to 25° C., from 2 to 20° C., from 3 to 20° C., from 3° C. to 15° C., or from 5 to 15° C., and the like. Conducting step (i) at lower temperatures generally results in superior product quality and organoleptic properties as compared to higher temperatures, as well as less saponification.

Prior to combining the oat flour composition and the base in step (i), and optionally, the oat flour composition (e.g., an aqueous mixture of an oat flour or an oat bran with water) can be contacted or combined with an enzyme at any suitable temperature. If used, the enzyme often is a beta-gluconase. It is believed that this enzyme modification improves the separation efficiency of the solid fraction from the liquid fraction.

In step (ii), the first aqueous mixture from step (i) is separated into a solid fraction and a liquid fraction. Generally, prior to the separating step, the first aqueous mixture has a solids content from 1 to 40 wt. %, such as from 2 to 30 wt. %, from 3 to 20 wt. %, or from 5 to 18 wt. %, although not limited thereto. Any suitable technique can be used to perform the separating step that results in a solid fraction and a liquid fraction, and such can be performed at any suitable conditions, although ambient temperature is convenient. Representative and non-limiting separation techniques that can be used in step (ii) include decanting, pressing, centrifuging, hydrocycloning, classifying, sieving, or sifting, and the like. Combinations or two or more of these techniques also can be utilized in step (ii).

Optionally, the liquid fraction of step (ii) can be further processed prior to step (iii) to remove a fat/oily fraction from the liquid fraction (which will be predominantly water based). If a fat/oily fraction is removed, the final oat composition will likely have a lower fat content as well as a better flavor profile, since the fat/oily fraction is highly susceptible to oxidation. Any suitable technique can be used to perform the remove the fat/oily fraction from the liquid fraction prior to step (iii), and such can be performed at any suitable conditions, although ambient temperature is convenient. As above, representative and non-limiting separation techniques that can be used include decanting, pressing, centrifuging, hydrocycloning, classifying, sieving, or sifting, and the like.

The liquid fraction in step (ii) and before step (iii) typically can have a solids content from 0.3 to 8 wt. %, and more often, the solids content of the liquid fraction ranges from 0.5 to 5 wt. % or from 1 to 4 wt. %. This liquid fraction contains globulin protein (oat protein), most of the fat from the oat flour composition, and typically from 0.1 to 0.4 wt. % soluble fiber.

On a dry basis, the protein content of the liquid fraction can range from 35 to 75 wt. % in one aspect, from 40 to 70 wt. % in another aspect, and from 40 to 65 wt. % in yet another aspect. The liquid fraction can have any suitable fat content, which can vary significantly depending upon the source and fat content of the oat flour composition. Nonetheless, ranges of fat content for the liquid fraction can include from 10 to 40 wt. % fat, from 12 to 38 wt. % fat, or from 15 to 35 wt. % fat, on a dry basis.

Prior to step (iii) and the acid addition, the liquid fraction can be cooled, heated, or maintained at generally ambient temperature. In one aspect, for instance, the liquid fraction can be heated to a temperature of up to and including ˜70° C. for a time period that can range from 1-5 minutes up to 3-4 hours, or more if desired.

In step (iii), the liquid fraction is combined with an acid to form a second aqueous mixture having a pH in a range from 5 to 9. Step (iii) can be referred to as a pH neutralization step prior to UF processing. The reduction in pH often can result in precipitation, thus the second aqueous mixture can be an aqueous slurry/suspension. The acid in step (iii) is not particularly limited, although often the acid is a food-grade acid. Illustrative and non-limiting examples of acids that can be used in step (iii) include citric acid, phosphoric acid, sulfuric acid, hydrochloric acid, acetic acid, or lactic acid, and the like. Combinations of two or more acids can be used.

After combining the liquid fraction with the acid in step (iii), the resulting second aqueous mixture has a pH in a range from 5 to 9. In some aspects, the pH in step (iii) can be in a range from 5 to 8.5; alternatively, from 5 to 8; alternatively, from 5.5 to 8.5; alternatively, from 5.5 to 7.5; alternatively, from 6 to 8.5; or alternatively, from 6 to 7.5.

In step (iv), the second aqueous mixture (some or all) is ultrafiltered to produce a UF permeate fraction and a UF retentate fraction. The second aqueous mixture can be ultrafiltered using ultrafiltration membranes with pore sizes that typically are in the 0.01 to 0.1 micron range. In certain industries, such as the dairy industry, the ultrafiltration membranes often are identified based on molecular weight cut-off (MWCO), rather than pore size. The molecular weight cut-off for ultrafiltration membranes can vary from 1,000-100,000 Daltons, or from 10,000-100,000 Daltons. For instance, the second aqueous mixture can be ultrafiltered using a polymeric membrane system (ceramic membranes also can be employed). The polymeric membrane system (or ceramic membrane system) can be configured with pore sizes such that the materials having molecular weights greater than 1,000 Daltons, greater than 3,000 Daltons, greater than 5,000 Daltons, or greater than 10,000 Daltons, are retained, while lower molecular weight species pass through. For instance, UF membrane systems with a molecular weight cut-off of 1,000-10,000 Daltons can be used in the dairy industry for separating and concentrating milk proteins. In some aspects, the step of ultrafiltering utilizes a membrane system having pore sizes in a range from 0.01 to 0.1 μm, and operating pressures typically in the 15-150 psig range, or the 45-150 psig range. While not being limited thereto, the ultrafiltration step often can be conducted at a temperature in a range from 3 to 15° C., such as from 4 to 12° C., or from 5 to 10° C. Ultrafiltering at lower temperatures generally results in superior product quality and organoleptic properties as compared to higher temperature ultrafiltration (e.g., ˜25-50° C.).

In an aspect of this invention, ultrafiltering the second aqueous mixture (some or all) in step (iv) can comprise diafiltering the second aqueous mixture through the ultrafiltration membrane. For instance, diafiltering the second aqueous mixture can comprise diafiltering a mixture of the second aqueous mixture and water, and this mixture can utilize any suitable proportions or relative amounts of the second aqueous mixture and water. While not wishing to be bound by theory, it is believed that the use of diafiltration in the UF step reduces the amount of oxidation products present in the UF retentate, with more of the off-flavor and off-odor compounds ending up in the UF permeate fraction.

The UF retentate fraction after the ultrafiltering step often has a solids content from 4 to 25 wt. % solids, and in some instances, from 5 to 20 wt. % solids, or from 7 to 18 wt. % solids. The protein content of the UF retentate fraction can vary significantly depending on the oat flour composition and the acid/base treatments, but generally, protein contents from 1 to 15 wt. %, from 2 to 14 wt. %, or from 3 to 12 wt. %, are typical. The UF retentate has a relatively low fat content, such as from 0 to 5 wt. %, from 0 to 3 wt. %, or from 0.5 to 4.5 wt. %. The mineral content of the UF retentate can vary from 0.01 to 0.7 wt. %, and from 0.05 to 0.5 wt. % and from 0.1 to 0.4 wt. % are representative ranges. The total dietary fiber content of the UF retentate can range from 0.5 to 5 wt. % in one aspect, from 1 to 5 wt. % in another aspect, and from 1 to 4 wt. % in yet another aspect, although not limited thereto. These compositional features of the UF retentate fraction in step (iv) are based on total weight of the UF retentate fraction.

Prior to step (v), and optionally, the HF retentate fraction can be contacted or combined with an enzyme at any suitable temperature. If used, the enzyme often is a protease. Additionally or alternatively, the second aqueous mixture—prior to ultrafiltering in step (iv)—can be contacted or combined with an enzyme (e.g., a protease) at any suitable temperature. It is believed that the protein hydrolysis step(s) increase(s) the solubility and the thermal stability of the protein, and results in a less gritty UF retentate fraction.

Step (v) of the method of making an oat composition comprises combining the UF retentate fraction, an ingredient, and optionally water to form the oat composition. Any combinations of these components can be mixed or combined, in any suitable relative proportions, to form the oat composition. In some aspects, at least the UF retentate fraction and the ingredient(s) can be combined to form the oat composition, while in other aspects, at least the UF retentate fraction, the ingredient(s), and water can be combined to form the oat composition.

One ingredient or a combination of ingredients can be added in the combining step. Non-limiting examples of suitable ingredients can include salt, a sugar/sweetener, a flavorant, a preservative (e.g., to prevent yeast or mold growth), a stabilizer, an emulsifier, a prebiotic substance, a probiotic bacteria, a vitamin, a mineral, an omega 3 fatty acid, a phyto-sterol, an antioxidant, or a colorant, and the like, as well as any mixture or combination thereof. In one aspect, the ingredient that is combined with the UF retentate fraction (and water, if desired) can comprise salt, while in another aspect, the ingredient that is combined with the UF retentate fraction (and water, if desired) can comprise a flavorant, and in yet another aspect, the ingredient that is combined with the UF retentate fraction (and water, if desired) can comprise both salt and the flavorant.

Optionally, the method for making the oat composition can further comprise a step of homogenizing the oat composition after step (v). Moreover, the method for making the oat composition also can further comprise a step of heat treating the oat composition after step (v). Suitable types of heat treatment can include pasteurization, extended shelf-life (ESL) heat treatment, or ultra-high temperature (UHT) sterilization, and the like. In one aspect, the step of heat treating can comprise pasteurizing at a temperature in a range from 80° C. to 95° C. for a time period in a range from 2 to 15 minutes. In another aspect, the step of heat treating can comprise UHT sterilization at a temperature in a range from 135° C. to 145° C. for a time period in a range from 1 to 10 seconds. In yet another aspect, the step of heat treating can comprise UHT sterilization at a temperature in a range from 148° C. to 165° C. for a time period in a range from 0 to 1 sec (e.g., 0.05 to 1 sec, 0.05 to 0.5 sec). Other appropriate pasteurization or sterilization temperature and time conditions are readily apparent from this disclosure. Further, this invention is not limited by the method or equipment used for performing the pasteurization/sterilization process—any suitable technique and apparatus can be employed, whether operated batchwise or continuously.

For instance, typical UHT sterilization techniques include indirect steam heating, direct steam injection, direct steam infusion, and the like. For indirect steam heating, the oat composition is not contacted directly with the heat source or heating medium, e.g., like a heat exchanger. Due to the heat transfer limitations, indirect heating requires a longer time for sterilization. Beneficially, in aspects of this invention, the oat composition is heat treated using direct UHT sterilization. In direct steam injection, high temperature steam is injected into the pipe or other vessel containing the oat composition, thus rapidly sterilizing the oat composition. Direct steam injection generally is performed continuously—a continuous flow of the oat composition is combined with a continuous injection of steam. In direct steam infusion, the oat composition is sprayed into a chamber containing steam, thus rapidly and uniformly sterilizing the oat composition. Like direct steam injection, direct steam infusion generally is performed continuously. After the heat treatment step, the oat composition can be cooled to any suitable temperature, such as in a range from 5° C. to 40° C., or from 10° C. to 30° C.

In some aspects of this invention, the method for making an oat composition, after a heat treatment step, can further comprise a step of packaging (aseptically or otherwise) the oat composition in any suitable container and under any suitable conditions. Thus, after combining the various components and ingredients as described herein to form the oat composition, the oat composition can be packaged under aseptic conditions (or non-aseptic conditions) in a container. Any suitable container can be used, such as might be used for the distribution and/or sale of oat-based products or beverages in a retail outlet. Illustrative and non-limiting examples of typical containers include a cup, a bottle, a bag, or a pouch, and the like. The container can be made from any suitable material, such as glass, metal, plastics, and the like, as well as combinations thereof.

Referring now to the solid fraction formed in step (ii) of the method for making an oat composition, this solid fraction can be very dense and sludge-like, and in some aspects of this invention, can be re-suspended in additional water, with or without the application of heat (increased temperature). If desired, the solid fraction after step (ii) can be subjected to a protein/starch hydrolysis treatment, and the hydrolysis treatment can comprise any suitable enzyme, such as an amylase, a protease, and the like. Typically, this hydrolysis treatment comprises an amylase.

A second liquid fraction then can be separated from the solid fraction. Any suitable technique can be used to perform this separating step, and such can be performed at any suitable conditions, although ambient temperature is convenient. Representative and non-limiting separation techniques that can be used to separate a second liquid fraction from the solid fraction can include decanting, pressing, centrifuging, hydrocycloning, classifying, sieving, or sifting, and the like. Combinations or two or more of these techniques also can be utilized in this separating step.

In the disclosed method for making an oat composition, the second liquid fraction optionally can be combined with the second aqueous mixture prior to step (iv) and ultrafiltering to form the herein described UF permeate and UF retentate fractions.

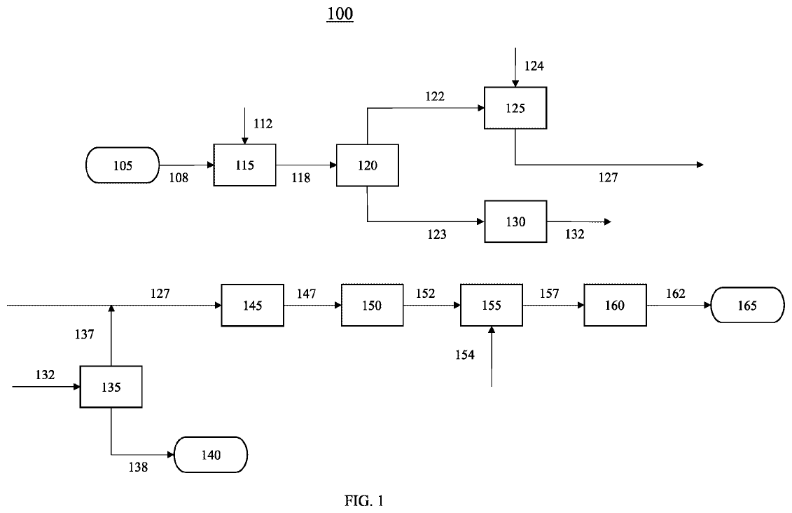

An illustrative and non-limiting example of a suitable separations process 100 consistent with aspects of the method of this invention is shown in FIG. 1. Initially, an oat flour composition 105 is introduced 108 into a suitable vessel 115 into which a base 112 is added, thereby producing a first aqueous mixture 118 having a pH of 8.5-11.5. A separations device 120 then separates the first aqueous mixture 118 into a solid fraction 123 and a liquid fraction 122, which is combined in vessel 125 with an acid 124 to form a second aqueous mixture 127 having a pH in a range from 5 to 9. The second aqueous mixture 127 is subjected to ultrafiltration 145 (optionally, with diafiltration) to produce a UF permeate fraction (not shown; mostly water) and a UF retentate fraction 147.

In FIG. 1, the UF retentate fraction 147 is subjected to protein hydrolysis 150 and then introduced 152 into a suitable vessel 155, where it is combined or mixed with one or more ingredients 154 to form an oat composition 157. Subsequently, the oat composition is homogenized 160 and then fed 162 to a thermal treatment system 165, such as UHT sterilization.

The solid fraction 123 exiting the separations device 120 is subjected to protein/starch hydrolysis 130 and the treated solid fraction 132 enters separations device 135. Exiting the separations device 135 are an insoluble fraction 138—which contains insoluble starch and fiber components and can be fed to a storage vessel 140—and a second liquid fraction 137. The second liquid fraction 137 can be combined with the second aqueous mixture 127 prior to ultrafiltration 145.

### EXAMPLES

The invention is further illustrated by the following examples, which are not to be construed in any way as imposing limitations to the scope of this invention. Various other aspects, modifications, and equivalents thereof which, after reading the description herein, can suggest themselves to one of ordinary skill in the art without departing from the spirit of the present invention or the scope of the appended claims.

Total solids (wt. %) were determined in accordance with procedure SMEDP 15.10 C by CEM Turbo Solids and Moisture Analyzer (CEM Corporation, Matthews, North Carolina). Ash is the residue remaining after ignition in a suitable apparatus at 550° C. to a constant weight; such treatment at 550° C. typically eliminates all organic matter, with the remaining material being primarily minerals (Standard Methods for the examination of dairy products, 17^{th} edition (2004), American Public Health Association, Washington DC). The ash test was performed by using a Phoenix (CEM Microwave Furnace), which heated the samples at 550° C. for 30 min. The mineral content (in wt. %) is generally similar to the ash content (wt. %), and thus the result of an ash test is used for quantification of the total mineral content in this disclosure. Protein content and fat content were determined by AOAC (Association of Official Analytical Chemists) methods. Total dietary fiber was determined by HPLC per AOAC 2011.25 and 2009.01 methods.

### Example 1

Example 1 was conducted by using portions of the process scheme shown in FIG. 1, and Table I summarizes the solids, minerals, fat, total dietary fiber (soluble fiber, low molecular weight, and high molecular weight), and protein contents of the relevant process streams in FIG. 1. The steps in the process were conducted at 3-10° C., unless stated otherwise. A starting slurry was formed by mixing water and the oat flour having the composition shown in Table I. After sufficient hydration time, the slurry was pH adjusted to 10.5 using a food grade sodium hydroxide. The resulting first aqueous mixture was agitated for a minimum of 10 minutes and optionally can be subjected to high shear such as found in a colloid mill or any other such mixing technology.

The first aqueous mixture, which had a solids content of 15.3 wt. % solids, was then subjected to centrifugal separation using a decanter separator. Optionally, a polishing separator can be used to further separate the protein and soluble fiber (liquid fraction) from the starch and insoluble fiber (solid fraction). The characteristics of the liquid fraction are shown in Table I.

A food grade hydrochloric acid was added to the liquid fraction to form the second aqueous mixture at a pH of 8.0, which after pH adjustment, was subjected to ultrafiltration (diafiltration of a combination of water and the second aqueous mixture thru a UF membrane) to produce a UF permeate fraction and a UF retentate fraction. The ultrafiltration unit employed membrane filters having a molecular exclusion range of −1,000-10,000 daltons. The UF membrane filters had a polysulfone/polypropylene support and a maximum pressure load of 150 psig. The characteristics of the UF retentate fraction are shown in Table I.

### Example 2

In Example 2, the UF retentate fraction of Example 1 was mixed with water and other ingredients, as shown in Table II to form an oat-based composition. This final oat composition, beneficially, exhibited a neutral flavor and creamy mouthfeel without the chalky texture typically found in traditional plant-based beverages. The oat composition (an oat-based beverage) in Table II also unexpectedly had the consistency, texture, and mouthfeel that was in between a standard 2% milk and whole milk.

TABLE I

| | Total | | | Total Dietary | |
|---|---|---|---|---|---|
| | Solids | Minerals | Fat | Fiber | Protein |
| Example 1 | (wt. %) | (wt. %) | (wt. %) | (wt. %) | (wt. %) |
| Oat Flour | 15.8 | 0.26 | 0.9 | 0.6 | 1.67 |
| Liquid Fraction | 2.1 | 0.13 | 0.5 | 0.3 | 0.9 |
| UF Retentate | 10.9 | 0.16 | 2.8 | 1.9 | 6.1 |

TABLE II

| | Amount |
|---|---|
| Example 2 | (grams) |
| UF Retentate | 100 |
| Water | 10 |
| Sugar | 2 |
| Dipotassium phosphate | 0.1 |
| Tricalcium phosphate | 0.1 |
| Salt | 0.1 |
| Flavor | 0.2 |

1. A method for making an oat composition, the method comprising:
(i) combining an oat flour composition with a base to produce a first aqueous mixture having a pH in a range from 8.5 to 11.5;
(ii) separating the first aqueous mixture into a solid fraction and a liquid fraction;
(iii) combining the liquid fraction with an acid to form a second aqueous mixture having a pH in a range from 5 to 9;
(iv) ultrafiltering the second aqueous mixture to produce a UF permeate fraction and a UF retentate fraction; and
(v) combining the UF retentate fraction, an ingredient, and optionally water to form the oat composition.

2. The method of claim 1, wherein the oat flour composition in step (i) has, on a dry basis:
a protein content from 7 to 30 wt. %;
a fat content from 0 to 10 wt. %; and
a total dietary fiber content from 2 to 20 wt. %.

3. The method of claim 1, wherein step (i) comprises combining the oat flour composition, the base, and optionally water to produce the first aqueous mixture having the pH in the range from 8.5 to 11.5.

4-5. (canceled)

6. The method of claim 1, wherein the base comprises sodium hydroxide, potassium hydroxide, calcium hydroxide, sodium carbonate, potassium carbonate, or any combination thereof.

7. (canceled)

8. The method of claim 1, further comprising a step of contacting the oat flour composition with an enzyme prior to step (i).

9. (canceled)

10. The method of claim 1, wherein the first aqueous mixture in step (ii) has a solids content from 1 to 40 wt. %.

11. The method of claim 1, wherein separating in step (ii) comprises decanting, pressing, centrifuging, hydrocycloning, classifying, sieving, sifting, or any combination thereof.

12. The method of claim 1, further comprising a step of removing a fat/oily fraction from the liquid fraction prior to step (iii).

13. The method of claim 1, wherein the liquid fraction in step (ii) and before step (iii) has:
a protein content from 35 to 75 wt. %, on a dry basis;
a fat content from 10 to 40 wt. %, on a dry basis; and
a solids content from 0.3 to 8 wt. %.

14-15. (canceled)

16. The method of claim 1, wherein the acid comprises citric acid, phosphoric acid, sulfuric acid, hydrochloric acid, acetic acid, lactic acid, or any combination thereof.

17. The method of claim 1, wherein ultrafiltering the second aqueous mixture in step (iv) comprises ultrafiltering the second aqueous mixture fraction through an ultrafiltration membrane having a molecular weight cut-off (MWCO) of 5,000 Daltons.

18. The method of claim 1, wherein ultrafiltering the second aqueous mixture in step (iv) comprises diafiltering the second aqueous mixture fraction through an ultrafiltration membrane.

19. The method of claim 1, wherein the UF retentate fraction in step (iv) has, based on total weight of the UF retentate fraction:
a solids content from 4 to 25 wt. %;
a protein content from 1 to 15 wt. %;
a fat content from 0 to 5 wt. %;
a mineral content from 0.01 to 0.7 wt. %; and
a total dietary fiber content from 0.5 to 5 wt. %.

20. The method of claim 1, further comprising:
a step of contacting the second aqueous mixture with an enzyme prior to ultrafiltering in step (iv); and/or
a step of contacting the UF retentate fraction with an enzyme prior to step (v).

21. (canceled)

22. The method of claim 1, wherein the ingredient comprises salt, a sugar/sweetener, a flavorant, a preservative, a stabilizer, an emulsifier, a prebiotic substance, a probiotic bacteria, a vitamin, a mineral, an omega 3 fatty acid, a phyto-sterol, an antioxidant, a colorant, or any combination thereof.

23. (canceled)

24. The method of claim 1, further comprising a step of heat treating the oat composition after step (v).

25. (canceled)

26. The method of claim 1, further comprising a hydrolysis treatment of the solid fraction after step (ii).

27. (canceled)

28. The method of claim 26, further comprising a step of separating a second liquid fraction from the solid fraction.

29. (canceled)

30. The method of claim 28, further comprising a step of combining the second liquid fraction with the second aqueous mixture prior to step (iv).

31-32. (canceled)
